(19) United States
(12) Patent Application Publication
(10) Pub. No.: US 2021/0212521 A1
(43) Pub. Date: Jul. 15, 2021

(54) Disposable cocktail shaker

(71) Applicant: Jesper Langgaard, Tilst (DK)

(72) Inventor: Jesper Langgaard, Tilst (DK)

(21) Appl. No.: 17/058,801

(22) PCT Filed: May 23, 2019
(86) PCT No.: PCT/EP2019/063329

§ 371 Date: Nov. 25, 2020

(30) Foreign Application Priority Data
May 25, 2018 (DK) PA 2018 70313
Aug. 9, 2018 (DK) PA 2018 00451

(51) Int. Cl. A47J 43/27

(52) U.S. Cl. CPC A47J 43/27

(57) ABSTRACT

The present invention relates to a disposable shaker comprising a) a first body configured as a drinking glass, and comprising a first cavity, and a first rim; b) a second body comprising a second rim, and a second cavity configured with multiple compartments; wherein each compartment comprises a cocktail ingredient of a cocktail to be prepared; wherein the first body and the second body are releasably attached to one another such that the first and second rims are positioned close to each other; and c) a tear-off or peel-off sleeve covering at least the upper part of the first rim's face.

### TECHNICAL FIELD OF THE INVENTION

The present invention relates to the field of disposable cocktail shakers.

### BACKGROUND OF THE INVENTION

Disposable cocktail shakers are known in many different embodiments, and substantially consisting of containers made of a bottom part, an upper part, and where the upper part is configured with a pouring spout or lip. However, only a few of them are configured for preparing single cocktails with multiple ingredients, and none of the latter are configured such that the cocktail can be enjoyed directly from the shaker.

### OBJECT OF THE INVENTION

The objective of the present invention is to provide a disposable shaker for preparing single cocktails with multiple ingredients that can be enjoyed directly from the shaker.

### Description of the Invention

A first aspect relates to disposable shaker comprising:
a first body configured as a drinking glass, and comprising a first cavity, and a first rim;
a second body comprising a second rim, and a second cavity configured with multiple compartments; wherein each compartment comprises a cocktail ingredient of a cocktail to be prepared;
   wherein the first body and the second body are releasably attached to one another such that the first and second rims are positioned close to each other; and
a tear-off or peel-off sleeve covering at least the upper part of the first rim's outer face.

The tear-off or peel-off sleeve serves three purposes. First, is serves as a label disclosing the type of cocktail, and the ingredients. Secondly, it serves to hold the first and second body together during display in a store or bar. Thirdly, it keeps the upper part of the first rim sterile, thereby allowing a user to drink from the first body without risk of being exposed to dirt and germs. The tear-off or peel-off sleeve may be made from any material suitable for such use, such as paper or plastic. In one or more embodiments, the tear-off or peel-off is a shrink sleeve.

In one or more embodiments, the first body is positioned upside down on the second body.

In one or more embodiments, the first body is positioned upside down on the second body, and wherein a part of the second rim is positioned within the first cavity such that its outer face is in contact with the inner face of the first rim, thereby releasably attaching the first body to the second body. Preferably, the tear-off or peel-off sleeve covers both at least the upper part of the first rim's outer face as well as a part of the second rim's outer face extending out of the first cavity.

In one or more embodiments, a bottom part of the second body is positioned within the first cavity.

In one or more embodiments, a bottom part of the second body is positioned within the first cavity, and wherein the second rim is configured for resting on the first rim in said position. Preferably, the tear-off or peel-off sleeve covers both a part of the first rim's outer face as well as a part of the second rim's outer face.

A second aspect relates to a disposable shaker comprising:
a first body configured as a drinking glass, and comprising a first cavity, and a first rim;
a second body comprising a second rim, and a second cavity configured with multiple compartments of a first type; wherein each compartment of a first type comprises a cocktail ingredient of a cocktail to be prepared;
   wherein the first body and the second body are releasably attached to one another such that the first and second rims are positioned close to each other;
   wherein the multiple compartments of a first type within the second cavity are formed by dividing walls having upper edges lying in a closure plane to provide sealing surfaces on which a peel-off lid sits in releasable sealing engagement;
   wherein the second rim extends above the upper edges of the dividing walls to form a compartment of a second type and positioned above the multiple compartments of a first type.

A third aspect of the present invention relates to a disposable shaker comprising:
a first body configured as a drinking glass, and comprising a first cavity, and a first rim;
a second body comprising a second rim, and a second cavity configured with multiple compartments; wherein each compartment comprises a cocktail ingredient of a cocktail to be prepared;
   wherein the first body and the second body are releasably attached to one another such that the first and second rims are positioned close to each other;
   wherein the multiple compartments within the second cavity are formed by dividing walls having upper edges lying in a closure plane to provide sealing surfaces on which a peel-off lid sits in releasable sealing engagement;
   wherein the second rim extends above the upper edges of the dividing walls to form an upper compartment sized and configured for holding ice cubes.

By using the shaker according to the present invention, the first body and the second body may be attached to one another to form a shaker, and with the second body facing the table top. This configuration allows the user to place ice cubes in the upper compartment of the second body after removing the peel-off lid, and just before attaching the first and second body to one another to shake the cocktail. Thereby the user will not have to pour the ingredients into the first body together with ice cubes before shaking/mixing the cocktail; a task that is difficult to do due to the dividing walls. The cocktail ingredients are then mixed together with the ice cubes by shaking the shaker. As the shaking process is finished, the shaker is positioned upside down, such that the first body is positioned on the table top.

In the present context, the term “rim” is to be understood as the upper open part of the first or second body, i.e. the opposite end than the bottom closed part.

In one or more embodiments, the disposable shaker further comprises a tear-off or peel-off sleeve covering at least the upper part of the first rim.

In the present context, the term “peel-off sleeve” is to be understood as a sleeve that can be removed by peeling it off, during normal use, without damaging the sleeve. Such a sleeve may e.g. be an elongate sheet or tape or strip or ribbon with two ends, and where one of the ends may function as a tab adapted for grabbing with precision grip. In this way, the sleeve may simply be peeled off. The back side of the sleeve may be completely or partly coated with an adhesive, and the front side of the sleeve may be used as a label.

In the present context, the term “tear-off sleeve” is to be understood as a sleeve that can be removed by tearing it off, during normal use, thereby damaging the sleeve. Such a sleeve may e.g. be an elongate sheet or tape or strip or ribbon with two ends, and where one of the ends may function as a tab adapted for grabbing with precision grip. The sleeve may comprise one or more perforation lines. In this way, the sleeve may simply be torn off. The back side of the sleeve may be completely or partly coated with an adhesive, and the front side of the sleeve may be used as a label.

In the present context, the term “disposable” indicates that the shaker is constructed in a manner consistent with single-use, including choice of materials, thickness of materials, and/or writing or other marking discouraging re-use.

In the present context, the term “drinking glass” shall mean any container or utensil similar to a drinking glass, whether or not the same is made of glass and used for drinking. The term “drinking glass” particularly includes all transparent drinking vessels made from glass and other materials, such as transparent plastics, and also any article simulating a drinking glass. The term “transparent” means allowing the transmission of light in the visible region, preferably having a visible light transmittance of 50% or more with a 1 mm material thickness.

In one or more embodiments, at least a part of the walls of the first body is made from a transparent material, such as poly-methyl methacrylate, thermoplastic polyurethane, polyethylene, polyethylene terephthalate, isophthalic acid modified polyethylene terephthalate, glycol modified polyethylene terephthalate, polypropylene, polystyrene, acrylic, polyacetate, cellulose acetate, polycarbonate, nylon, glass, polyvinyl chloride, and mixtures thereof.

In one or more embodiments, the first body is configured as a stemmed drinking glass.

In one or more embodiments, the first body is positioned upside down on the second body, and wherein the second rim is positioned within the first cavity, thereby releasably attaching the first body to the second body. The configuration allows the user to see how to assemble the shaker.

In one or more embodiments, a bottom part of the second body is positioned within the first cavity. This configuration allows for the disposable shakers to be stackable, when presented in a cocktail bar or convenience store.

In one or more embodiments, a bottom part of the second body is positioned within the first cavity, and wherein the tear-off or peel-off sleeve is covering at least a part of the first and second rims. Thereby, the first and second bodies are fixed together.

In one or more embodiments, the second body comprises dividing walls for dividing the cavity into multiple compartments.

In one or more embodiments, the second body comprises a lid, e.g. configured as a foil or membrane, such as a peelable foil or membrane. The flat lid allows for securing the cocktail ingredients from mixing prior to use, thereby allowing for prolonged storage. In one or more embodiments, the disposable shaker comprises a lid, such as a peel-off lid, configured to retain the cocktail ingredients within the multiple compartments.

In one or more embodiments, the multiple compartments within the second cavity are formed by dividing walls having upper edges lying in a closure plane to provide sealing surfaces on which a peel-off lid sits in releasable sealing engagement.

In one or more embodiments, the second body comprises dividing walls, and a flat lid; wherein the peripheral walls and the dividing walls all have upper edges lying in a closure plane to provide sealing surfaces on which the flat lid sits in sealing engagement. The flat lid allows for securing the cocktail ingredients from mixing prior to use, thereby allowing for prolonged storage.

Each of the sealing surfaces are sufficiently wide, and sufficiently rigid for the lid to be pressed into sealing engagement with the top of the second body.

In one or more embodiments, the second body comprises dividing walls, and wherein the upper edges of the dividing walls are sharpened or tapered. This configuration provides for better shearing and mixing of the ingredients.

In one or more embodiments, the multiple compartments are positioned only in the lower part of the second cavity.

In one or more embodiments, at least a part of the walls of the first body is made from a transparent material, such as poly-methyl methacrylate, thermoplastic polyurethane, polyethylene, polyethylene terephthalate, isophthalic acid modified polyethylene terephthalate, glycol modified polyethylene terephthalate, polypropylene, polystyrene, acrylic, polyacetate, cellulose acetate, polycarbonate, nylon, glass, polyvinyl chloride, and mixtures thereof. The transparency allows for a better representation of the cocktail in the first body/drinking glass.

In one or more embodiments, the second body and the first body are configured with cone-shaped sides.

In one or more embodiments, the second body comprises a compartment configured for receiving a sealed container comprising a liquid cocktail ingredient, such as alcohol and/or soda and/or juice. The sealing may be a foil, a membrane, a cap, or the like.

As used in the specification and the appended claims, the singular forms “a”, “an”, and “the” include plural referents unless the context clearly dictates otherwise. Ranges may be expressed herein as from “about” or “approximately” one particular value and/or to “about” or “approximately” another particular value.

When such a range is expressed, another embodiment includes from the one particular value and/or to the other particular value. Similarly, when values are expressed as approximations, by use of the antecedent “about”, it will be understood that the particular value forms another embodiment.

It should be noted that embodiments and features described in the context of one of the aspects of the present invention also apply to the other aspects of the invention.

### BRIEF DESCRIPTION OF THE FIGURES

FIG. 1 shows a side view of a disposable shaker in accordance with various embodiments of the invention;

FIG. 2 shows a perspective view of individual components of a disposable shaker in accordance with various embodiments of the invention;

FIG. 3 shows a side view of a group of stacked disposable shakers in accordance with various embodiments of the invention;

FIGS. 4-5 show a schematic instruction on how to use a disposable shaker in accordance with various embodiments of the invention; and

FIG. 6 shows an exploded view of a second body in accordance with various embodiments of the invention with peel-off lid, and cocktail ingredients.

### REFERENCES

100 Disposable shaker
200 First body
210 First cavity
220 First rim
300 Second body
310 Second rim
320 Second cavity
330 Compartment
340 Bottom part
350 Dividing walls
352 Upper edge
360 Compartment
400 Tear-off or peel-off sleeve
410 Tap
500 Peel-off lid
510 Tap
600 Cocktail ingredients

### DETAILED DESCRIPTION OF THE INVENTION

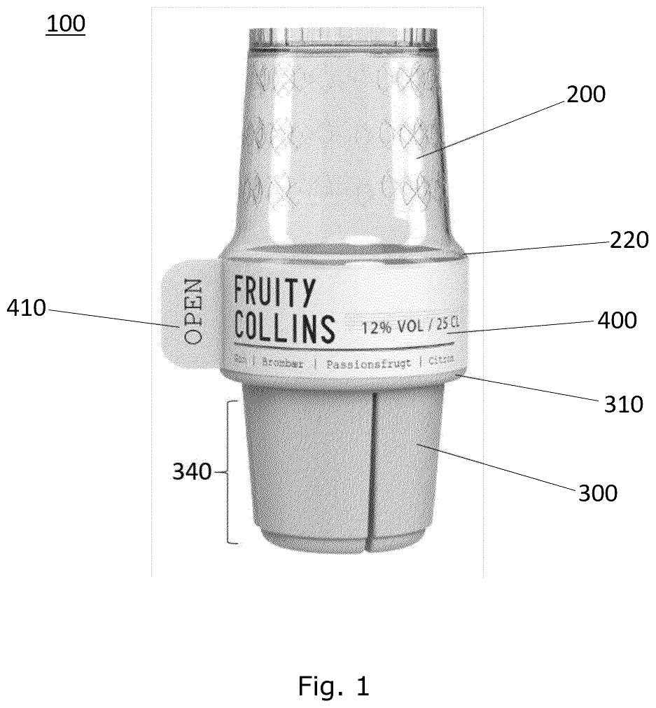

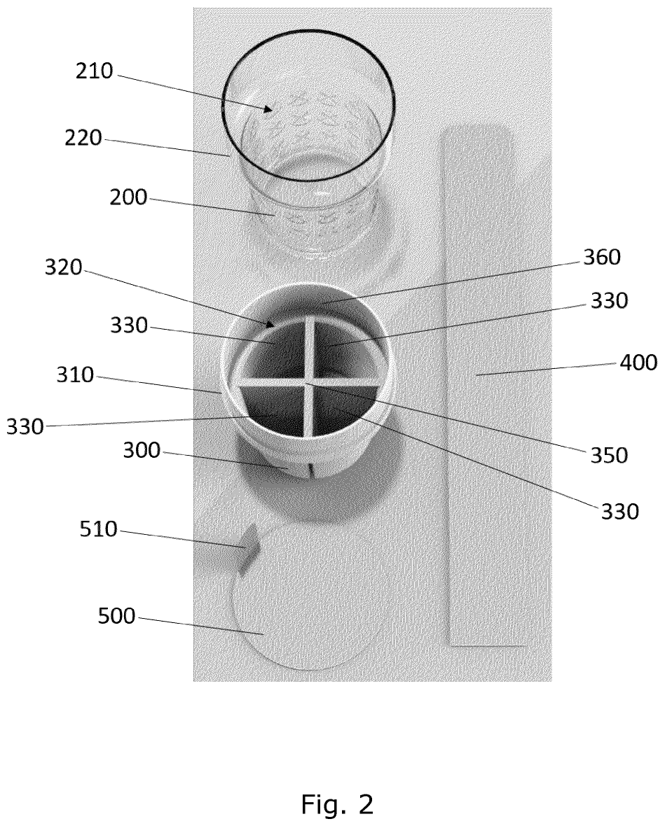

FIG. 1 shows a side view of a disposable shaker 100 in accordance with various embodiments of the invention. The disposable shaker 100 comprises a first body 200 configured as a drinking glass, and a second body 300 with multiple compartments 330 (FIG. 2) each comprising a cocktail ingredient of a cocktail to be prepared. The first body 200 is positioned upside down on the second body 300 such that their respective rims 220, 310 (first and second rims) are positioned close to each other. A part of the second rim 310 is positioned within the first cavity 210 (FIG. 2) such that its outer face is in contact with the inner face of the first rim 220, thereby releasably attaching the first body to the second body 300. The inner face is to be understood as the part facing the cavity of either first or the second body, and the outer face as being the opposite face. The peel-off sleeve 400 is shown covering most of the first 220 and the second 310 rims' outer faces. A tap 410 is present to make it easier to peel of the sleeve 400. The tap 410 is a free end of the sheet material constituting the sleeve 400.

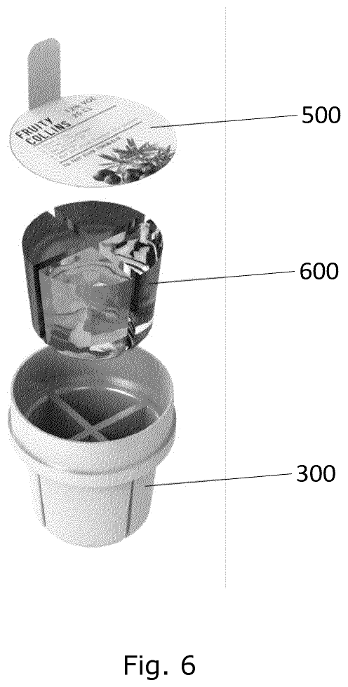

FIG. 2 shows a perspective view of individual components of a disposable shaker in accordance with various embodiments of the invention and positioned on a tablecloth. The disposable shaker is shown comprising a peel-off lid 500 configured to retain the cocktail ingredients within the multiple compartments 330 of the second body 300. A tap 510 is present to make it easier to peel of the lid 500. The multiple compartments 330 (of a first type) within the second cavity 320 are formed by dividing walls 350 having upper edges lying in a closure plane to provide sealing surfaces on which a peel-off lid 500 sits in releasable sealing engagement. The multiple compartments 330 are positioned only in the lower part of the second cavity 320. The second rim 310 extends above the upper edges 352 of the dividing walls 350 to form a compartment 360 of a second type and positioned above the multiple compartments 330 of a first type. FIG. 6 shows an exploded view of a second body in accordance with various embodiments of the invention with peel-off lid 500, and cocktail ingredients 600.

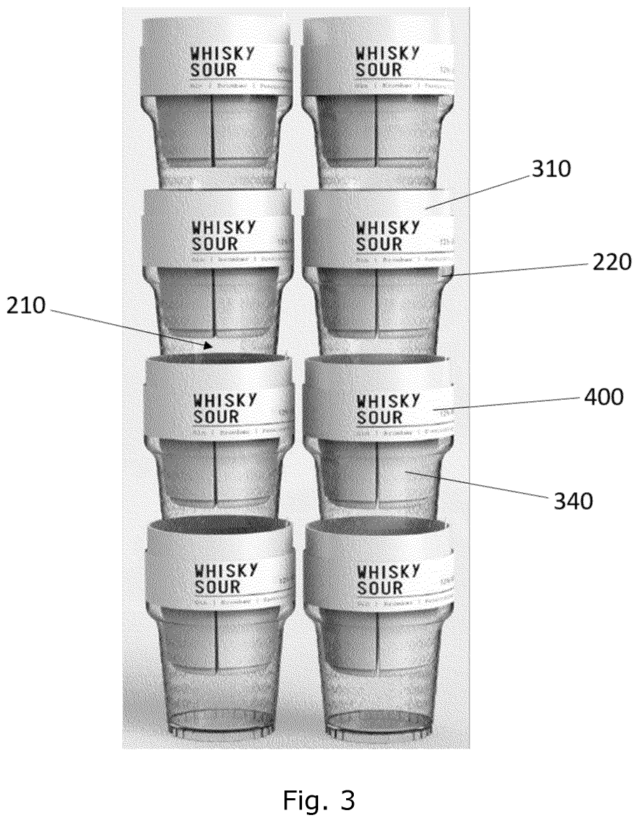

Another way to represent the shaker before use is as shown in FIG. 3. Here, a bottom part 340 of the second body 300 is positioned within the first cavity 210. The peel-off sleeve 400 is covering a part of the first 220 and second 310 rims' outer faces. This configuration allows for the disposable shakers to be stacked, when presented in a cocktail bar or convenience store.

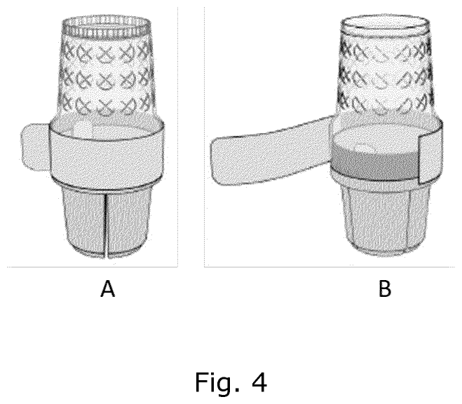

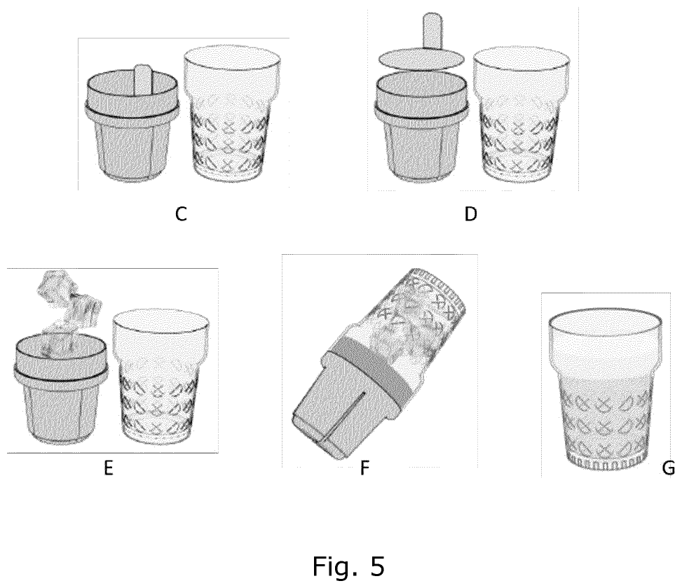

FIGS. 4-5 show a schematic instruction on how to use a disposable shaker in accordance with various embodiments of the invention.

1. A disposable shaker (100) comprising:
a first body (200) configured as a drinking glass, and comprising a first cavity (210), and a first rim (220);
a second body (300) comprising a second rim (310), and a second cavity (320) configured with multiple compartments (330); wherein each compartment (330) comprises a cocktail ingredient of a cocktail to be prepared;
wherein the first body (200) and the second body (300) are releasably attached to one another such that the first rim (220) and the second rim (310) are positioned close to each other; and
a tear-off or peel-off sleeve (400) covering at least an upper part of an outer face of the first rim (220).

2. The disposable shaker (100) according to claim 1, wherein the first body (200) is positioned upside down on the second body (300), and wherein a part of the second rim (310) is positioned within the first cavity (210) such that an outer face of the second rim is in contact with an inner face of the first rim (310), thereby releasably attaching the first body (200) to the second body (300); wherein the tear-off or peel-off sleeve (400) covers both at least the outer face of the upper part of the first rim (220) as well as a part of the outer face of the second rim (310) extending out of the first cavity (210).

3. The disposable shaker (100) according to claim 1, wherein a bottom part (340) of the second body (300) is positioned within the first cavity (210), and wherein the second rim (310) is configured for resting on the first rim (220) when the second body is positioned within the first cavity; wherein the tear-off or peel-off sleeve (400) covers both a part of the outer face of the first rim (220) as well as a part of the outer face of the second rim (310).

4. The disposable shaker (100) according to claim 1, wherein the tear-off or peel-off sleeve (400) is a shrink sleeve.

5. The disposable shaker (100) according to claim 1, wherein the tear-off or peel-off sleeve (400) comprises one or more perforation lines.

6. The disposable shaker (100) according to claim 1, wherein a back side of the tear-off or peel-off sleeve (400) is completely coated with an adhesive.

7. The disposable shaker (100) according to claim 1, further comprising a peel-off lid (500) releasably attached to the multiple compartments (330) and configured to retain the cocktail ingredient (600) within each of said multiple compartments (330).

8. The disposable shaker (100) according to claim 1, wherein the multiple compartments (330) within the second cavity (320) are formed by dividing walls (350) having upper edges lying in a closure plane to provide sealing surfaces on which a peel-off lid (500) sits in releasable sealing engagement.

9. The disposable shaker (100) according to claim 8, wherein the upper edges of the dividing walls (350) are sharpened or tapered.

10. The disposable shaker (100) according to claim 5, wherein the tear-off or peel-off sleeve (400) is a shrink sleeve.

11. The disposable shaker (100) according to claim 1, wherein the multiple compartments (330) are positioned only in a lower part of the second cavity (320).

12. The disposable shaker (100) according to claim 1, wherein at least a part of walls of the first body (200) is made from a transparent material selected from the group consisting of poly-methyl methacrylate, thermoplastic polyurethane, polyethylene, polyethylene terephthalate, isophthalic acid modified polyethylene terephthalate, glycol modified polyethylene terephthalate, polypropylene, polystyrene, acrylic, polyacetate, cellulose acetate, polycarbonate, nylon, glass, polyvinyl chloride, and mixtures thereof.
